(19) United States
(12) Patent Application Publication
(10) Pub. No.: US 2020/0050347 A1
(43) Pub. Date: Feb. 13, 2020

(54) ELECTRONIC MAKEUP MIRROR DEVICE AND SCRIPT OPERATION METHOD THEREOF

(71) Applicant: CAL-COMP BIG DATA, INC., NEW TAIPEI CITY (TW)

(72) Inventors: Chia-Ming Yong, New Taipei City (TW); Min-Chang Chi, New Taipei City (TW)

(73) Assignee: CAL-COMP BIG DATA, INC., NEW TAIPEI CITY (TW)

(21) Appl. No.: 16/188,305

(22) Filed: Nov. 13, 2018

(30) Foreign Application Priority Data
Aug. 13, 2018 (CN) 201810915298.7

(51) Int. Cl. G06F 3/0484; G06F 3/0481; G06F 3/0482; G06K 9/00; G06T 7/00

(52) U.S. Cl. CPC G06F 3/04847; G06F 3/04817; G06F 3/0482; G06T 2207/30201; G06T 7/0012; G06T 2207/30088; G06K 9/00228

(57) ABSTRACT

The disclosure provides an electronic makeup mirror device having a screen, an image capturing device, a storage device, and a processor. The screen displays a current image. The image capturing device captures the current image. The storage device stores a plurality of scripts and a plurality of modules, each of the plurality of scripts includes call sequence parameters corresponding to the selected modules and module setting parameters corresponding to each of the selected modules. The processor receives the selecting operation to select an enabled script in the plurality of scripts. The processor performs an operation corresponding to the selected module according to the call sequence parameter and the module setting parameter of the enabled script, then displays a result image respectively through the screen in response to the operation result of the operation, wherein the result image includes the current image and the operation result.

### CROSS-REFERENCE TO RELATED APPLICATION

This application claims the priority benefit of Chinese application serial no. 201810915298.7, filed on Aug. 13, 2018. The entirety of the above-mentioned patent application is hereby incorporated by reference herein and made a part of this specification.

### BACKGROUND OF THE DISCLOSURE

### Technical Field

The disclosure relates to an electronic makeup mirror device and a script operation method thereof.

### Background

It is human nature to make oneself look good; however, it is not easy to stay beautiful. There is a lot for one to do in basic care every morning and before bedtime as well as in doing makeup when going out. For example, the steps taken for basic care are quite cumbersome, and the skin care products used in the mornings and evenings are not the same. Moreover, in each of the steps taken for skin care, the products are chosen depending on user's skin type and season. Additionally, the user's face, skin tone, outfit and purpose need to match different cosmetics and makeup. Accordingly, the cumbersome steps for skin care can easily cause one to give up on keeping the routine. In some cases, when there is not much time left before going out, the user has to omit some steps in order to be able to go out on time. Even if the user performs these steps carefully, it is likely to miss some steps due to nervousness, which even causes the user to be late for work or date. Therefore, it is an issue for practitioners of the field to find out how to help the user to stay beautiful while maintaining the pace of life.

### SUMMARY

The disclosure is related to an electronic makeup mirror device and a script operation method thereof, so that the electronic cosmetic minor device can provide a user with a smooth and complete skin care and makeup process by executing a script operation method.

According to an embodiment of the disclosure, an electronic makeup minor device has a screen, an image capturing device, a storage device, and a processor. The screen displays a current image. The image capturing device is coupled to the screen for capturing the current image. The storage device stores a plurality of scripts and a plurality of modules, wherein each of the plurality of scripts has a call sequence parameter corresponding to a selected module of the plurality of modules and a module setting parameter corresponding to each of the selected modules. The processor is coupled to the screen and the storage device, and the processor receives a selecting operation to select an enabled script in the plurality of scripts. The processor performs an operation corresponding to the selected modules according to the call sequence parameter and the module setting parameter of the enabled script. The processor displays a result image through the screen in response to the operation result of the operation respectively, wherein the result image includes a current image and an operation result.

According to an embodiment of the disclosure, a script operation method is adapted for an electronic makeup mirror device, wherein the electronic makeup mirror device comprises a screen, an image capturing device, a storage device and a processor. The script operation method has the following steps. The processor receives a selecting operation to select an enabled script in a plurality of scripts, wherein the plurality of scripts are stored in the storage device, and each of the plurality of scripts includes a call sequence parameter corresponding to a selected module of a plurality of modules and a module setting parameter corresponding to each of the selected modules. The processor performs operation corresponding to the selected modules according to the call sequence parameter and the module setting parameter of the enabled script. The processor displays a result image through the screen in response to the operation result of the operation respectively, wherein the result image includes a current image and an operation result.

Based on the above, the electronic makeup mirror device and the script operation method of the disclosure allow the user to set scripts corresponding to different circumstances by establishing scripts. In this manner, the electronic makeup mirror device prompts the user to perform the makeup and skin care process according to the script and displays various types of information to the user, so that the user can gradually complete various steps without being in a hurry. As such, the electronic makeup mirror device and the script operation method of the disclosure allow the user to keep the pace of life while staying beautiful.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic system diagram showing an electronic makeup mirror device according to an embodiment of the disclosure;

FIG. 2 is a schematic diagram showing the circuit connection of an electronic makeup mirror device according to an embodiment of the disclosure;

FIG. 3 is a flow chart showing performing a script operation method of an electronic makeup mirror device according to an embodiment of the disclosure;

FIG. 4 and FIG. 5 respectively show conversion result images according to an embodiment of the disclosure;

FIG. 6A and FIG. 6B are diagrams showing a result image displayed according to a test result of a skin test module in different scripts according to an embodiment of the disclosure;

FIG. 7 is a flow chart showing the operation of an electronic makeup mirror device according to an embodiment of the disclosure;

FIG. 8 is a diagram showing a list of scripts provided by an electronic makeup mirror device according to an embodiment of the disclosure; and

FIG. 9A and FIG. 9B are schematic diagrams showing the operation of a script editing module according to an embodiment of the disclosure.

### DETAILED DESCRIPTION OF DISCLOSED EMBODIMENTS

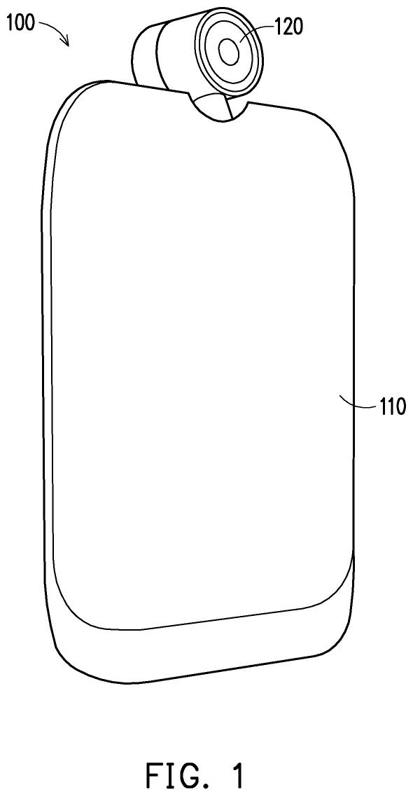

FIG. 1 is a schematic system diagram showing an electronic makeup mirror device according to an embodiment of the disclosure. Referring to FIG. 1, an electronic makeup mirror 100 has a screen 110 and an image capturing device 120.

The screen 110 displays a current image and various types of information provided by the electronic makeup mirror device 100. In an embodiment of the disclosure, the screen 110 is a combination of a mirror and a display. The mirror is formed of a material (for example, a mirror) having high reflective index for displaying the current image, such as the user's image and the background image thereof, through light refraction. The display s disposed behind the mirror for displaying various information. For example, the display may be a liquid crystal display (LCD), an organic light-emitting diode (OLED) display, or a thin film transistor liquid crystal display (TFT-LCD) or the like, the disclosure is not limited thereto. In an embodiment of the disclosure, the display may also be various types of touch display, such as a capacitive touch display, a resistive touch display, and the like. Through the combination of the mirror and the display, the user can see himself/herself through the mirror and can also view various types of information.

The image capturing device 120 is for capturing an image. The image capturing device 120 is, for example, a video camera or a camera embedded in the electronic makeup mirror device 100, or a mobile phone, a camera, or the like that is externally connected to the electronic makeup mirror device. The disclosure is not limited thereto.

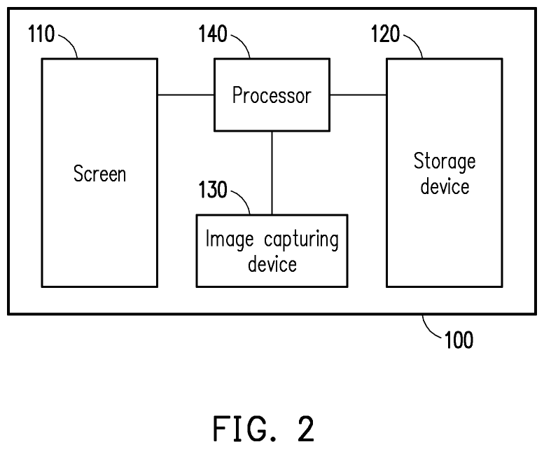

FIG. 2 is a schematic diagram showing the circuit connection of an electronic makeup mirror device according to an embodiment of the disclosure. Referring to FIG. 2, the electronic makeup mirror device 100 further includes a storage device 130 and a processor 140. Moreover, the screen 110, the image capturing device 120 and the storage device 130 are electrically connected to the processor 140.

The storage device 130 stores essential program codes and data for the operation of the electronic makeup mirror device 100. In particular, the storage device 130 also stores a plurality of scripts and modules. The storage device 130 is, for example, any type of fixed or movable random access memory (RAM), a read-only memory (ROM), a flash memory, a hard disk drive (HDD), a solid state drive (SSD) or the like or a combination of the above elements, the disclosure is not limited thereto.

It should be noted that the modules stored in the storage device 130 are, for example, a time prompting module, a skin test module, a product recommendation module, a makeup prompting module, a commute information acquiring module, an intelligence notifying module, a weather module, a music playback module, and a face detection module, script building module, and the like, the disclosure is not limited thereto.

The time prompting module is used to provide the current time of the system. In addition, the user may also set event reminders corresponding to a plurality of different event times through the time prompting module. The event reminder set by the user is, for example, a wake-up alarm at 7 am, a prompt to go out at 8 am, and the like, the disclosure is not limited thereto.

The skin test module is configured to analyze the current image captured by the image acquiring device 120 to provide skin condition test, skin age test, and the like. For example, the test result of the skin condition obtained through the skin test module is that the skin is dry and the dark circles are too obvious. In some cases, the skin test module may also provide a test result showing that the skin age is 25 years old.

The product recommendation module provides a corresponding product according to the skin test results analyzed by the skin test module. For example, in the foregoing example, the product recommendation module provides suitable lotions and creams as well as eye creams that remove dark circles to the user according to the result of dry skin. In some cases, the product recommendation module recommends a product suitable for 25-year-old skin to the user.

The makeup prompting module is configured to provide makeup guidance according to the user's image captured by the image capturing device 120, for example, providing a plurality of different makeup styles for the user to select, and displaying the suggested makeup contour and colors according to the makeup style selected by the user and the user's image. The disclosure provides no limitation to the implementation details of the makeup prompting module.

Further, the makeup prompting module recommends the most preferable makeup guidance according to the skin test results (especially, the skin condition test result) and the remaining time for going out obtained from the time prompting module, for example, when the user got up late and only 5 minutes are left for preparation, if the skin test result is that the most serious skin problem is dark circles, the most preferable makeup guidance suggests only dark circles be dealt with. In addition, the makeup prompting module has a learning arithmetic sub-module. Since not everyone spends the same time in doing makeup, the learning arithmetic sub-module records and learns the makeup time consumed by the user in each part every time the user does makeup, calculates the makeup time and converts into the time generally consumed for each part, and performs calculation with the remaining time for preparation obtained by the time prompting module, thereby acquiring the most preferable makeup guidance. For example, if the most serious skin problem of the user is dark circles, and the time spent by the user on makeup for the dark circles in five consecutive working days is: 2 minutes, 2 minutes and 30 seconds, 2 minutes, 1 minute and 50 seconds, and 2 minutes and 5 seconds, the makeup prompting module obtains that the makeup time spent by the user on dark circles is 2 minutes and 5 seconds in general according to the makeup time. Therefore, if the remaining time for preparation is 5 minutes, the makeup prompting module determines that the remaining time is enough for the user to apply makeup to the dark circles, and then provide the makeup guidance corresponding to dark circles according to the current image. In other embodiments of the disclosure, the makeup prompting module may further determine the makeup time generally spent by the user on a plurality of different parts, and further provide makeup guidance corresponding to the plurality of parts according to the remaining time, and the disclosure is not limited thereto.

It should be noticed that, in an embodiment of the disclosure, the method for obtaining the makeup time consumed by the user is, for example, the makeup prompting module provides the makeup guidance in sequence according to the parts, and therefore, the makeup prompting module records the time during which the makeup guidance for this part begins to be provided and switched to the next makeup guidance. In some cases, the makeup prompting module may analyze the time consumed by the user on each part through the image capturing device 120, the disclosure is not limited thereto.

The intelligence notifying module provides a variety of different types of prompts, such as dietary advice, health advice, sleep advice, latest news, etc. In addition, the intelligence notifying module provides corresponding advice based on the skin test results. The commute information acquiring module obtains corresponding traffic information according to the destination address specified by the user and the home address, or provides corresponding traffic information according to the transportation information set by the user. For example, if the user drives to work, the home address and the company address may be set in advance, and the commute information acquiring module can obtain traffic information from the home to the company, such as traffic flow, accidents, etc., and then estimate the traffic time and display it to the user. Alternatively, the user may set the number or time of the vehicle to be taken in advance, and the commute information acquiring module can display and provide it to the user and also acquire the corresponding news or time, for example, a delay notice. The music playback module is used to play various music. The weather module obtains corresponding weather information according to the current time of the system and provide it to the user.

It should be noticed that, other than providing makeup guidance for a plurality of parts according to the time for leaving, the above-mentioned makeup prompting module suggests another the most preferable makeup guidance according to the weather information acquired by the weather module, for example, when the weather module obtains weather information indicating that the UV level is too high or the air quality is not good today, the makeup prompting module provides makeup guidance suggesting using products that reinforce facial protection for blocking sunlight/dirty air. It should be noted that, in an embodiment of the disclosure, the most preferable makeup guidance may provide suggestions according to the information obtained from at least one of the time prompting module and the weather module. However, the makeup prompting module also records module weight parameters. Accordingly, when it is necessary to use the information of both the time prompting module and the weather module, the makeup prompting module may be adjusted according to the module weight parameter. For example, if the remaining time provided by the time prompting module is only enough for the user to deal with the dark circles, however, according to the weather information, the makeup prompting module determines that it is important to do facial protection for blocking sunlight/dirty air, on this occasion, the makeup prompting module may provide a corresponding makeup guidance according to the module weight parameter set by the user in advance. For example, in the module weight parameters, the weight of the time prompting module is higher than the weight of the weather information module. Therefore, the makeup prompting module prioritizes the remaining time information of the time prompting module higher to provide the makeup guidance, that is, only dealing with the dark circles.

The face detection module is used to detect whether the user is within the detection range. For example, when the time prompting module is prompting the user to wake up, if the face detection module detects the user's face, it means that the user has already gotten up. On this occasion, the time prompting module may turn off the wake-up reminder according to the detection result of the face detection module. Or, when the time prompting module is prompting the user to go out, if the face detection module does not detect the user's face within a preset time (for example, 2 minutes), it represents that the user has left the house. On this occasion, the time prompting module may turn off the go-out reminder according to the detection result of the face detection module. However, if the face detection module detects the user's face after the time of the go-out reminder, the time prompting module continues to send the go-out reminder according to the detection result of the face detection module to urge the user to go out quickly. Or, in an embodiment of the disclosure, the condition for stopping the operation of the script is that when the face detection module does not detect the user's face within a preset time, it represents that the user has left the house, and the processor 140 stops operation of the script.

The script building module is used to provide a function of building scripts to allow the user to select a module and set a call sequence to generate call sequence parameters. The user may also enter module setting parameters through the script building module.

In addition, each script has a preset situation mode, such as work, dates, holidays, travel, and so on. In these scripts, a call sequence parameter corresponding to a selected module of the plurality of modules and a module setting parameter corresponding to each of the selected modules are stored. The call sequence parameters are the order of calling the corresponding modules. For example, in the script for going to work, the call sequence parameters are, for example, sequence 1, time prompting module and music playback module; sequence 2, intelligence notifying module, commute information acquiring module, skin test module, makeup prompting module, product recommendation module; sequence 3, time prompting module. As such, when this script is operated, the modules of sequence 1, sequence 2, and sequence 3 are run sequentially. Alternatively, the call sequence parameter may be time prompting module and music playback module at 6 am; intelligence notifying module, skin test module, commute information acquiring module, makeup prompting module, and the product recommendation module at 6:10 am; time prompting module at 7:25 am, that is, the call sequence parameters may be specifically set as an exact time for operation.

The module setting parameters are the parameters used by the module when the executed modules are recorded. According to the above case, in the script for going to work, the module setting parameters are, for example, sequence 1, the time prompting module is a wake-up reminder at 6 am, and the music playback module is playing a playlist created by the user; sequence 2, the intelligence notifying module randomly provides dietary information and health information at 6:10 am, the skin test module prompts the user to test skin, the commute information acquiring module displays commute information from home to company, the makeup prompting module is makeup parameter for work style, and the product recommendation module looks for and displays the recommended products corresponding to the user's skin condition; sequence 3, the time prompting module is a go-out reminder at 7:25 am.

The processor 140 performs various types of calculation when the electronic makeup mirror device 100 is in operation. In particular, the processor 140 also executes the aforementioned modules in accordance with a script. For example, the processor 140 displays on the screen 110 that analysis and calculations are made based on the image acquired by the image capturing device 120. The processor 140 is, for example, a central processing unit (CPU), a microprocessor, an application specific integrated circuit (ASIC), a programmable logic device (PLD), or the like.

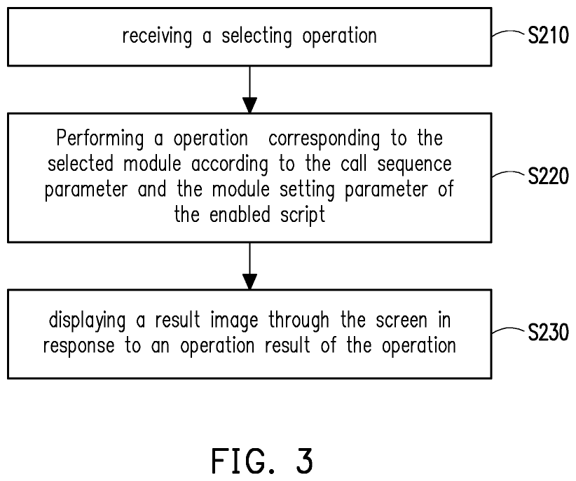

FIG. 3 is a flow chart showing performing a script operation method of an electronic makeup mirror device according to an embodiment of the disclosure. Details of the operation of the electronic makeup mirror device 100 of the disclosure are described below with reference to FIG. 1 to FIG. 3.

In step S210, the processor 140 receives selecting operation to select an enabled script among the plurality of scripts stored by the storage device 130. In the description below, the enabled script is a script selected by the user and run by the processor 140, that is, the processor 140 only runs the enabled script, and the rest of the scripts are only stored in the storage device 130. In the disclosure, if the electronic makeup mirror device 100 is provided with a touch screen, the user may select an enabled script to be operated among a plurality of scripts through the touch screen. Alternatively, the user may also connect a Bluetooth or wireless network of a personal terminal device (e.g., a mobile phone) to the electronic makeup mirror device 100 to send a selected operation to the electronic makeup mirror device 100.

In step S220, the processor 140 performs an operation corresponding to the selected modules according to the call sequence parameters and the module setting parameters of the enabled script.

The previous script for working day is described for exemplary purpose. When the script for working day is run, firstly, the processor 140 sets and performs the operation corresponding to the time prompting module according to the module setting parameter, that is, the wake-up reminder is sent by the time prompting module at 6 am. Moreover, the processor 140 calls the music playback module to play the playlist created by the user.

Next, the processor 140 calls the intelligence notifying module and randomly provides dietary information and health information, the skin test module prompts the user to perform skin test, the commute information acquiring module acquires the commute information from home to company, the makeup prompting module obtains the makeup parameters for work style, and the product recommendation module obtains recommended products for corresponding skin condition.

The processor 140 sends a go-out reminder through the time prompting module at 7:25 am.

In step S230, the processor 140 displays a result image through the screen 110 in response to the operation result of the operation. The result image has a current image and an operation result, thereby displaying various types of information while the user is looking in the mirror.

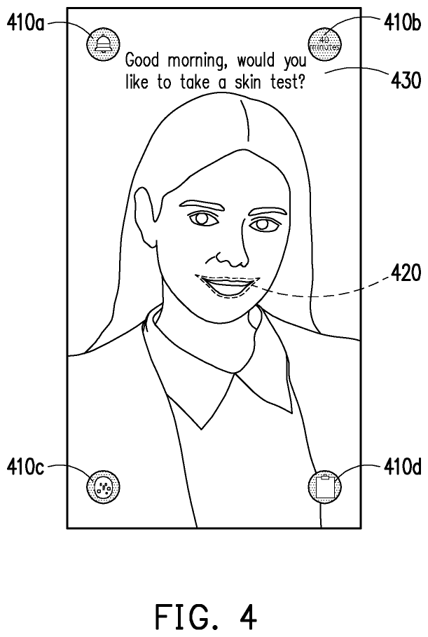

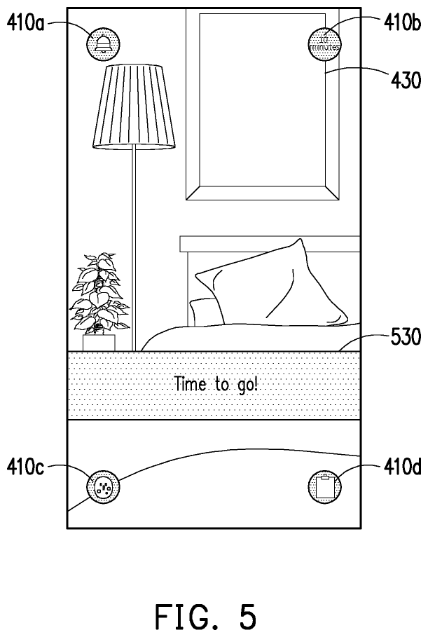

For example, FIG. 4 and FIG. 5 respectively show conversion result images according to an embodiment of the disclosure. Referring to FIG. 4 first, the result image is a result image displayed by the processor 140 that performs operation according to the sequence 2 of the call sequence parameters and the corresponding module setting parameters in the script for working day. An icon 410a displays a prompt of the intelligence notifying module, and the user may click on the icon 410a to open or zoom-out the randomly played dietary information or health information. An icon 410b displays commute information which is that, in the embodiment, for example, the bus taken by the user is set to depart in 40 minutes. The time information displayed by the icon 410b is continuously updated as time progresses to provide instant commute information to the user. An icon 410c displays a prompt for skin test, and the user may click on the icon 410c to enable a skin test. In this manner, the skin test module captures the current image through the image capturing device 120 and analyzes the current image. An icon 410d displays a recommended product corresponding to the skin condition of the user. It should be noted that the processor 140 may achieve the prompting function by integrating various display modes, such as flashing, discoloring, distortion, playing music, and so on. For example, if the commute information acquired by the commute information acquiring module is only 10 minutes left, the processor 140 may integrate the discoloring approach so that the icon 410b displays “10 minutes” in red letter with yellow background. Alternatively, the processor 140 may integrate the flashing approach to make the icon 410c to flash to prompt the user to perform skin test. Other than the display mode, the processor 140 may also prompt the user to perform skin test through a text box 430.

In addition to the above, for the facial image of the user, the processor 140 integrates the makeup parameters acquired by the makeup prompting module and the facial image of the user, thereby displaying a makeup guidance 420 on the facial image.

Referring to FIG. 5, the result image is a result image displayed by the processor 140 that performs operation according to the sequence 3 in the call sequence parameters and the corresponding module setting parameter in the script for working day. In FIG. 5, since the processor 140 does not call other modules again, the icons 410a through 410d are retained. However, in the time prompting module of sequence 3 called by the processor 140, a go-out reminder 530 at 7:25 am is integrated in the conversion result image.

It should be indicated that in the embodiment of the disclosure, the same module provides different information under scripts of different situation. In general, the time for preparation is not much before going to work, so the processor 140 sets the script for working day to be simplified and brief Accordingly, when executing the various modules, the processor 140 may control the various modules to execute a simplified mode to perform simple measurements and analysis and generate short comments. In the script for time off work, the processor 140 controls various modules to perform a complete mode to generate a complete analysis, a comment or a reminder. In an embodiment of the disclosure, the processor 140 automatically presets the brief/complete mode parameters of the modules according to the situation. However, the user may further manually adjust the brief/complete mode parameters, the disclosure is not limited thereto.

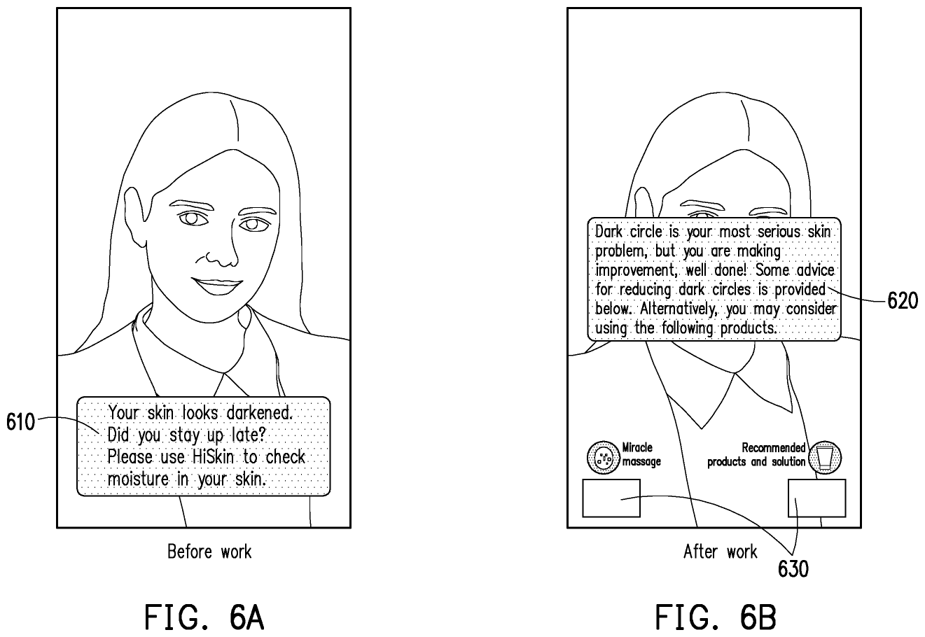

Referring to FIG. 6A and FIG. 6B, FIG. 6A and FIG. 6B are diagrams showing a result image displayed according to a test result of a skin test module in different scripts according to an embodiment of the disclosure. FIG. 6A is a result image of executing the skin test module in the script for working day. In a dialog 610 of FIG. 6A, the conversion results image provides simplified test and suggestions for skin care solely based on the user's current focus on skin defects. However, FIG. 6B is a result image of executing the skin test module in the script for time off work. As compared with the script for working day, the dialog 620 performs a more complete and accurate test for the skin, in particular, the skin test module records the test and generates a comprehensive test result through comparing the previous skin test results. Other than that, the icon 630 is provided in the conversion result image, and the user may obtain the suggestion corresponding to the skin condition provided by the skin test module by clicking on the icon.

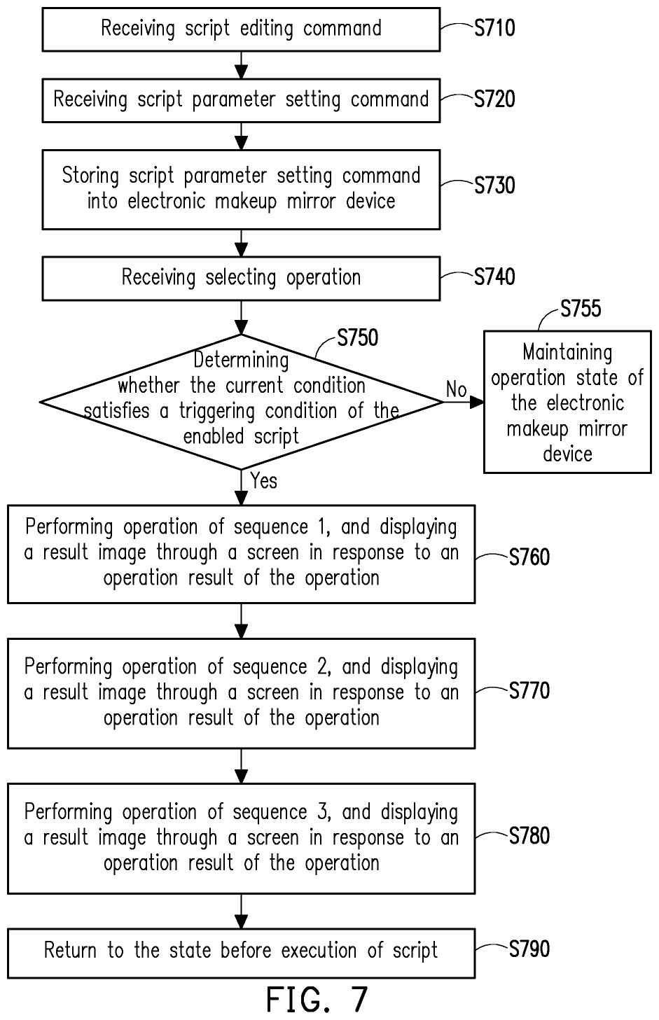

FIG. 7 is a flow chart showing the operation of an electronic makeup mirror device according to an embodiment of the disclosure. The process from building the script and running the script by the electronic makeup mirror device 100 of the disclosure are described below with reference to FIG. 1 to FIG. 2 and FIG. 7.

In step S710, the processor 140 receives a script editing command to open a script editing page of the electronic makeup mirror device 100. As described above, in the disclosure, if the electronic makeup mirror device 100 is provided with a touch screen, the user may select an enabled script to be operated among a plurality of scripts through the touch screen. Alternatively, the user may connect Bluetooth or wireless network of a personal terminal device (e.g., a mobile phone) to the electronic makeup mirror device 100 to send a selecting operation to the electronic makeup mirror device 100.

In step S720, the processor 140 receives a script parameter setting command. At this time, the processor 140 calls the script editing module and provides various script basic parameters as well as script function parameters for the user to select and set. The script basic parameters are parameters used by the electronic makeup mirror device 100 when the script is run, for example, setting parameters such as a background image of the script, a wake-up phrase, a simplified or a complete mode. The script function parameter is an action performed by the electronic makeup mirror device 100 when the script is run, for example, the aforementioned module and the functions provided thereby. In this manner, the user may set the functions and information provided by the script. The processor 140 further generates corresponding call sequence parameters and module setting parameters according to the setting function edited by the user.

In step S730, the processor 140 stores the script parameter setting command in the storage device 130 of the electronic makeup mirror device 100. In step S740, the processor 140 receives the selecting operation. It should be noted that the step that the processor 140 receives the selecting operation may be combined in step S720, that is, when the processor 140 receives the script editing command, the selecting operation is also received such that the script can be run directly after the user edits the script. Alternatively, the user may also send the selecting operation after storing the script editing command. In other words, the disclosure provides no limitation to the time at which the user selects a script.

In step S750, the processor 140 determines whether the current condition satisfies the triggering condition of the enabled script. Specifically, in the disclosure, the user may set the triggering condition of the script. For example, the triggering condition may be set to run repeatedly during the week. Accordingly, the processor 140 determines that it is weekday on Monday, and therefore executes the script. Alternatively, if the triggering condition set by the user is immediate execution, the processor 140 executes the script immediately after receiving the selecting operation. It should be noted that if the processor 140 does not receive the triggering command of the script and the current condition does not satisfy any triggering conditions for enabling the script, the processor 140 continues to maintain the state of operation of the electronic makeup or device 100.

In steps S760 to S780, the processor 140 performs the operations of the sequence 1 to the sequence 3, respectively, and displays the result image through the screen 110 in response to the operation result of the operation. It should be noted that the sequence 1 to the sequence 3 are steps generated according to the script for the foregoing working day. In the actual operation of the electronic makeup minor device, steps S760 to S780 may be further adjusted into different number according to the number of actual sequences set by the user. The disclosure is not limited thereto.

Step S760 is described for exemplary purpose. In this step, the processor 140 calls the module of sequence 1 according to the call sequence parameter and the module setting parameter of the enabled script, and performs the operation corresponding to the selected modules. For example, the processor 140 sends a wake-up reminder and plays music at 6 am according to the call sequence parameters and the module setting parameters. Steps S770 to S780 are similar to step S760, and thus are not repeated herein.

In step S790, the processor 140 makes the electronic makeup mirror device 100 to return to the state before execution of the script.

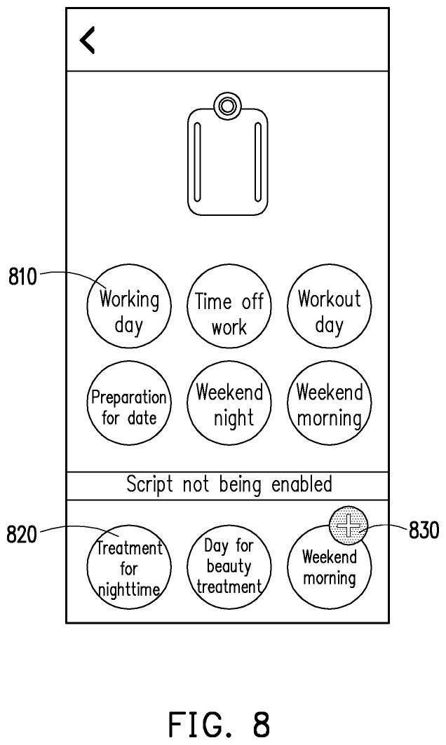

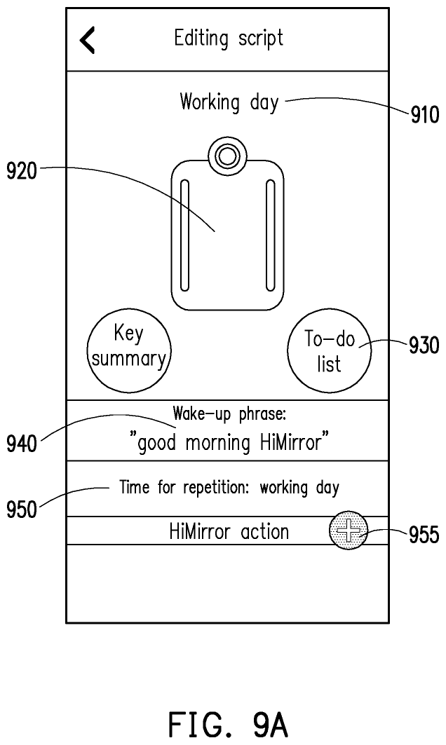

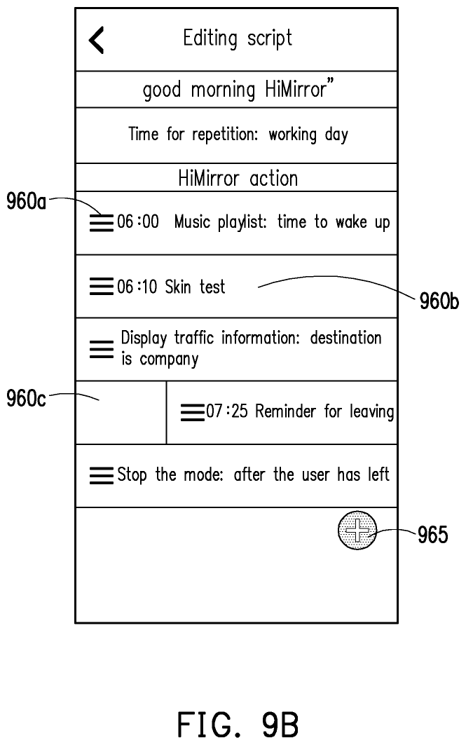

In order to make the disclosure clear and easily comprehensible, the image and details of creating script according to an embodiment of the disclosure are described below with reference to FIG. 8 to FIG. 9B.

FIG. 8 is a diagram showing a list of scripts provided by an electronic makeup mirror device according to an embodiment of the disclosure. Referring to FIG. 8, the electronic makeup mirror device 100 provides an enabled script list 810 and a script list 820 that has not been enabled. The enabled script list 810 includes working days, days of work, workout days, preparation for dates, weekend nights, and weekend mornings.

The script 820 that has not been enabled is a script that is preset or call sequence parameters and module setting parameters of corresponding module created by the user, but is neither enabled nor designated to be executed at a specific time.

Upon receiving a click operation of any of the scripts, the processor 140 enables the script editing module to provide a script editing image for the user to edit. In addition, the electronic makeup mirror device 100 provides an icon 830 simultaneously. When the icon 830 is clicked on, the processor 140 enables the script editing module to allow the user to create a new script.

FIG. 9A and FIG. 9B are schematic diagrams showing the operation of a script editing module according to an embodiment of the disclosure. Referring to FIG. 9A, in the editing image provided in operation of the script editing module, the user may input the name of the script in a field 910, and a preview image edited by the user is displayed in a pattern 920. An icon 930 is used to display user-defined display icon parameters. For example, please refer to both of FIG. 4 and FIG. 9A. In the embodiment, if the user automatically displays the icon 930 as a to-do list and a key summary, the icon 410c and the icon 410d in FIG. 4 are changed to display to-do list and key summary. It should be pointed out that if the functions set by the icon 410c and the icon 410d are different, the module called by the processor 140 is affected. Therefore, the processor 140 further adjusts the call sequence parameters and the module setting parameters according to the display icon parameters, and the disclosure is not limited thereto.

In field 940, the user may further set the wake-up phrase parameters. In the embodiment, the wake-up phrase parameter is “Good Morning, HiMirror”, that is, when the electronic makeup mirror device 100 detects, through configuration of microphone, that the user has said the phrase “Good Morning, HiMirror” corresponding to the wake-up phrase parameter, the script for working day is triggered, i.e., the processor 140 enables the script for working day.

In field 950, the user may specify the time for enabling script and whether execution is repeated. For example, a script for working day is executed repeatedly on working days.

In addition, the user may further click on the icon 955 to add other parameters, such as setting a background picture, setting a ring tone of call, and the like.

Referring to FIG. 9B, the editing image of FIG. 9B is the image following FIG. 9A. Fields 960a-960c are used to allow the user to select the script functions provided by the electronic makeup mirror device 100. In other words, fields 960a-960c are actually provided to allow the user to set call sequence parameters as well as module setting parameters. The user may edit and adjust the sequence of the established actions in different manners such as dragging, long pressing, and sliding to the left or right. Alternatively, the user may also click on an icon 965 to create a new action. It should be noted that in the embodiment of the disclosure, the user does not need to add all script functions to the script. In other words, not all modules are called by the processor 140, and only the selected module that is selected and added to the script by the user are called and executed by the processor 140.

In this embodiment, the processor 140 executes the corresponding modules according to the order of the fields 960a-960c. In other words, the order of the fields 960a-960c affects the call sequence parameters generated by the processor 140. The processor 140 generates module setting parameters according to the information set by the user in the fields 960a-960c, for example, the music playlist is the one named “time to get up”, the destination is company, and the like. However, the information and parameters of the embodiment are merely illustrative, and the disclosure is not limited thereto.

In this embodiment, the method of stopping operation of the script is to detect that the user has left the house through the face detection module, and then it is determined to stop operating the script. However, in other embodiments, the operation of the script may be stopped according to time or other means, and the disclosure is not limited thereto.

In addition, the electronic makeup mirror device 100 may also provide other different script basic parameters to allow the user to do customized settings. For example, different scripts may adopt different background pictures depending on the user's choice. Further, there are simplified/complete mode parameters in the script function parameters to allow the user to designate whether each module is executed in complete mode or simplified mode. It should be noted that the disclosure provides no limitation to the foregoing disclosed modules, parameters, images, operation interfaces (e.g., fields, icons, etc.), and any modules, parameters, images, operation interfaces in the electronic makeup mirror device that can be operated and assist the user in terms of reminding, doing makeup, looking beautiful, and the like to achieve a better quality of life may be applied to the disclosure.

In summary, the electronic makeup mirror device and the script operation method of the disclosure allow the user to set scripts corresponding to different circumstances by establishing scripts. In this manner, the electronic makeup mirror device prompts the user to perform the makeup and skin care process according to the script and displays various types of information to the user, so that the user can gradually complete various steps without being in a hurry. Additionally, the electronic makeup mirror device and the script operation method also provide various services, such as skin test, product recommendation or makeup guidance, according to the needs set by the user. In some cases, various types of information, e.g., traffic condition, is provided according to the needs set by user. Meanwhile, the electronic minor device is equipped with the function of time prompt. As such, there is no need for the user to keep thinking and look up what is the next step, what product and cosmetic are required, how much time is left, the traffic condition and so on. Therefore, the user may focus on completing the makeup and skin care process with the time that is saved. As such, the electronic makeup minor device and the script operation method of the disclosure allow the user to keep the pace of life while staying beautiful.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic makeup mirror device, comprising:
a screen, displaying a current image;
an image capturing device, coupled to the screen for capturing the current image;
a storage device, storing a plurality of scripts and a plurality of modules, wherein each of the plurality of scripts comprises a call sequence parameter corresponding to a selected module of the plurality of modules and a module setting parameter corresponding to each of the selected modules; and
a processor, coupled to the screen and the storage device, receiving a selecting operation to select an enabled script in the plurality of scripts,
the processor performs an operation corresponding to the selected modules according to the call sequence parameter and the module setting parameter of the enabled script,
the processor respectively displays a result image through the screen in response to an operation result of the operation, wherein the result image comprises the current image and the operation result.

2. The electronic makeup mirror device according to claim 1, wherein the processor further receives a script parameter setting command, where the script parameter setting command comprises a script basic parameter and a script function parameter,
the processor further stores the script parameter setting command in the storage device,
the processor further generates the call sequence parameter and the module setting parameter according to the script function parameter.

3. The electronic makeup minor device according to claim 2, wherein the script basic parameter further comprises a wake-up phrase parameter, and the processor further performs the operation corresponding to the selected module according to the call sequence parameter and the module setting parameter of the enabled script when detecting a wake-up phrase corresponding to the wake-up phrase parameter.

4. The electronic makeup mirror device according to claim 2, wherein the script basic parameter further comprises a display icon parameter, and the processor further adjusts the call sequence parameter and the module setting parameter according to the display icon parameter and the operation result in response to the operation.

5. The electronic makeup minor device according to claim 2, wherein the script function parameter further comprises a simplified/complete mode parameter, and the processor further runs the corresponding module according to the simplified/complete mode parameter.

6. The electronic makeup minor device according to claim 1, wherein the processor further determines whether a current condition satisfies a triggering condition of the enabled script,
the processor further performs the operation corresponding to the selected module according to the call sequence parameter and the module setting parameter of the enabled script when the current condition satisfies the triggering condition of the enabled script.

7. The electronic makeup minor device according to claim 1, wherein the module further comprises a face detection module,
the processor stops running the enabled script when the face detection module does not detect a face image corresponding to the user at a preset time.

8. The electronic makeup mirror device according to claim 1, wherein the module comprises at least one of a time prompting module, a skin test module, a makeup prompting module, an intelligence notifying module, and a weather module, wherein,
the time prompting module provides a current time and an event reminder of a corresponding event time,
the skin test module analyzes the current image to provide a skin test result,
the makeup prompting module provides a corresponding makeup guidance according to the current image,
the intelligence notifying module provides suggested information corresponding to the skin test result,
the weather module acquires and provides weather information.

9. The electronic makeup minor device according to claim 8, wherein
the makeup prompting module further comprises a learning arithmetic sub-module recording a plurality of makeup time corresponding to a face portion of the current image, and generates a normal makeup time according to the plurality of makeup time,
the makeup prompting module acquires a remaining time according to the current time and the event time, and provides the makeup guidance according to the remaining time, the skin test result, the normal makeup time, and the current image.

10. The electronic makeup mirror device according to claim 8, wherein the makeup prompting module further provides the makeup guidance according to the weather information, or the current time and the event time; or
the makeup prompting module further records a module weight parameter, and the makeup prompting module further provides a corresponding makeup guidance according to the module weight parameter, the weather information, the current time and the event time.

11. A script operation method, adapted for an electronic makeup mirror device, wherein the electronic makeup mirror device comprises a screen, an image capturing device, a storage device and a processor, wherein the storage device stores a plurality of modules, and the plurality of modules are executed by the processor, the method comprising:
receiving a selecting operation by the processor to select an enabled script in a plurality of scripts, wherein the plurality of scripts are stored in the storage device, and each of the plurality of scripts comprises a call sequence parameter corresponding to a selected module of the plurality of modules and a module setting parameter corresponding to each of the selected modules,
performing an operation corresponding to the selected module by the processor according to the call sequence parameter and the module setting parameter of the enabled script; and
displaying a result image respectively through the screen by the processor in response to an operation result of the operation, wherein the result image comprises a current image and the operation result.

12. The script operation method according to claim 11, further comprising:
receiving a script parameter setting command by the processor, the script parameter setting command comprises a script basic parameter and a script function parameter;
storing the script parameter setting command by the processor into the storage device; and
generating the call sequence parameter and the module setting parameter by the processor according to the script function parameter.

13. The script operation method according to claim 12, wherein the script basic parameter further comprises a wake-up phrase parameter, and the script operation method further comprises:
when a wake-up phrase corresponding to the wake-up phrase parameter is detected by the processor, performing the operation corresponding to the selected module respectively according to the call sequence parameter and the module setting parameter of the enabled script.

14. The script operation method according to claim 12, wherein the script basic parameter further comprises a display icon parameter, and the script operation method further comprises:
adjusting the call sequence parameter and the module setting parameter by the processor according to the display icon parameter and the operation result in response to the operation.

15. The script operation method according to claim 12, wherein the script function parameter further comprises a simplified/complete mode parameter, and the script operation method further comprises:
running the corresponding module by the processor according to the simplified/complete mode parameter.

16. The script operation method according to claim 11, the script operation method further comprises:
determining whether a current condition satisfies a triggering condition of the enabled script by the processor; and
if the current condition satisfies the triggering condition of the enabled script, performing the operation corresponding to the selected module by the processor according to the call sequence parameter and the module setting parameter of the enabled script.

17. The script operation method according to claim 11, wherein the module further comprises a face detection module, and the script operation method further comprises:
stopping running the enabled script when the processor does not detect a face image corresponding to the user at a preset time.

18. The script operation method according to claim 11, wherein the module comprises at least one of a time prompting module, a skin test module, a product recommendation module, a makeup prompting module, a commute information acquiring module, an intelligence notifying module, and a weather module, wherein the script operation method further correspondingly comprises the following according to the module:
providing a current time and an event reminder of a corresponding event time by the time prompting module;
analyzing the current image by the skin test module to provide a skin test result;
providing a recommended product by the product recommendation module according to the skin test result;
providing a corresponding makeup guidance by the makeup prompting module according to the current image;
acquiring corresponding traffic information by the commute information acquiring module according to a destination address and a home address;
providing suggested information corresponding to the skin test result by the intelligence notifying module; and
obtaining and providing weather information by the weather module.

19. The script operation method according to claim 18, wherein the makeup prompting module further comprises a learning arithmetic sub-module, and the script operation method further comprises:
recording a plurality of makeup time corresponding to a face portion of the current image by the learning arithmetic sub-module, and generating a normal makeup time according to the plurality of makeup time; and
obtaining a remaining time by the makeup prompting module according to the current time and the event time, and providing a most preferable makeup guidance according to the remaining time, the skin test result, the normal makeup time, and the current image.

20. The script operation method according to claim 18, further comprising:
providing a most preferable makeup guidance by the makeup prompting module according to the weather information, or the current time and the event time; or
recording a module weight parameter by the makeup prompting module, and the makeup prompting module further provides the corresponding most preferable makeup guidance according to the module weight parameter, the weather information, and the current time and the event time.
